(19) United States
(12) Patent Application Publication
(10) Pub. No.: US 2022/0381362 A1
(43) Pub. Date: Dec. 1, 2022

(54) VALVE CONTROL DEVICE

(71) Applicant: HANGZHOU GREAT STAR INDUSTRIAL CO., LTD., Hangzhou CIty (CN)

(72) Inventor: Weiyi WANG, Hangzhou City (CN)

(73) Assignee: HANGZHOU GREAT STAR INDUSTRIAL CO., LTD., Hangzhou City (CN)

(21) Appl. No.: 17/885,855

(22) Filed: Aug. 11, 2022

Related U.S. Application Data
(63) Continuation-in-part of application No. PCT/CN2020/080191, filed on Mar. 19, 2020.

(51) Int. Cl. F16K 31/04

(52) U.S. Cl. CPC F16K 31/042; F16K 31/043

(57) ABSTRACT

Disclosed is a valve control device, comprising: a drive unit; an execution mechanism, connected to the drive unit by a transmission mechanism, attached to a valve, and configured to be able to move under the drive of the drive unit, so as to drive the valve to rotate; and a control module, connected to the drive unit, and configured to be able to control the drive unit. The valve control device according to the present invention may be mounted on an existing manually operated valve in a pipeline such as a water pipeline or a gas pipeline, and it is not necessary to remodel the existing valve and pipeline, so that the valve can be remotely, intelligently, and automatically controlled, and a water leakage situation, a gas leakage situation or the like caused by untimely response are avoided.

### CROSS REFERENCE TO RELATED APPLICATION

The present application is a continuation-in-part of International Application No. PCT/CN2020/080191 filed on Mar. 19, 2020, the disclosure of which is incorporated herein in its entirety by reference.

### FIELD OF THE INVENTION

The present invention relates to the technical field of valve structures, and in particular, to a valve control device.

### DESCRIPTION OF THE PRIOR ART

In daily life, valves are critical devices for controlling the opening and closing of a water path and a gas path in families. There are manual valves and electric valves in the prior art. Generally, electric valves are highly automated, safe, and reliable and have been widely used. However, electric valves require relatively high costs. A large number of manual valves are still used at present. In a family that uses a manual valve, if a water leakage situation, a gas leakage situation or the like occurs when nobody is at home, the property in the family may suffer damage and in severe cases a safety accident may occur. If the manual valve is to be replaced with an electric valve, it is required to purchase the electric valve and also to remodel a pipeline, resulting in relatively high costs and a relatively complex remodeling process.

Therefore, a person skilled in the art strives to develop a valve control device that can be directly mounted, adjusted, and used without remodeling an existing valve structure, can be conveniently detached and mounted, and can monitor the status and remote operation of a valve in real time, such that the valve can be turned off in time when nobody is present.

### SUMMARY OF THE INVENTION

In view of the foregoing deficiencies in the prior art, the technical problem to be resolved by the present invention is to provide a valve control device, so that an existing manually operated valve can be monitored in real time and remotely operated, to avoid that a person is not on site and cannot handle a gas leakage situation, a water leakage situation or the like in time.

To achieve the foregoing objective, the present invention provides a valve control device, comprising:

a drive unit;

an execution mechanism, connected to the drive unit by a transmission mechanism, and configured to be able to be attached to a valve and be able to move under the drive of the drive unit, so as to drive the valve to rotate; and

a control module, connected to the drive unit, and configured to be able to control the drive unit.

In some implementations, optionally, the device further comprises:

a communication module, connected to the control module, and configured to be able to: receive a control signal about the valve, and provide the control signal to the control module, wherein

the control module is further configured to be able to respond to the control signal provided by the communication module to correspondingly control the drive unit according to the control signal.

In some implementations, optionally, the device further comprises:

a detection module, configured to be able to: detect position information of the valve, and provide the position information to the control module, wherein the control module is further configured to be able to correspondingly control the drive unit according to the position information.

In some implementations, optionally, the detection module comprises a current detection unit, the current detection unit is connected to the drive unit, and the current detection unit is configured to be able to detect whether a current of the drive unit is greater than a preset value so as to generate information about whether the valve rotates to a preset position.

In some implementations, optionally, the detection module comprises a trigger unit, and the trigger unit is configured to be able to be triggered to generate a signal indicating that the valve rotates in position when the valve rotates to the preset position.

In some implementations, optionally, the valve control device further comprises a trigger member, and the trigger member is configured to be able to: rotate along with the execution mechanism, and trigger the trigger unit when the valve rotates to the preset position.

In some implementations, optionally, the transmission mechanism comprises:

a driving gear, connected to the drive unit, and capable of rotating under the drive of the drive unit; and

at least one driven gear, capable of correspondingly rotating along with the drive of the driving gear, wherein one of the at least one driven gear is connected to the execution mechanism and is provided with the trigger member.

In some implementations, optionally, the trigger member comprises a first protrusion and a second protrusion, the first protrusion is configured to be able to trigger the trigger unit when the valve is located at a first position; and the second protrusion is configured to be able to trigger the trigger unit when the valve is located at a second position.

In some implementations, optionally, the at least one driven gear comprises:

a first driven gear, engaged with the driving gear; and

a second driven gear, engaged with the first driven gear, wherein the second driven gear is connected to the execution mechanism, and the second driven gear is provided with the trigger member.

In some implementations, optionally, the valve control device further comprises a switching mechanism, and the switching mechanism is connected to the first driven gear.

In some implementations, optionally, the switching mechanism comprises a pull shaft, an elastic element, and a pull ring, wherein the first driven gear is sheathed over the pull shaft and configured to be able to move along with the pull shaft, the elastic element is configured to apply an elastic force to the first driven gear, and the pull ring is disposed at an end portion, away from the first driven gear, of the pull shaft; and the switching mechanism is configured to: when the pull shaft is applied with a force in a direction away from the first driven gear, enable the first driven gear to be driven by the pull shaft and overcome the elastic force so as to be disengaged from the second driven gear.

In some implementations, optionally, the execution mechanism comprises a first block sheet and a second block sheet that are arranged opposite each other, and an accommodating space capable of placing a handle is formed between the first block sheet and the second block sheet.

In some implementations, optionally, the execution mechanism is provided with an adjustment mechanism, and the adjustment mechanism is configured to be able to adjust a gap between the first block sheet and the second block sheet.

In some implementations, optionally, the adjustment mechanism comprises: a first slide groove provided in the first block sheet, a second slide groove provided in the second block sheet, and a locking portion, wherein the first slide groove and the second slide groove are configured to be disposed in an overlapping cross manner, and the locking portion passes through the first slide groove and the second slide groove.

In some implementations, optionally, the valve control device further comprises a fixing mechanism and a shell, wherein a housing and a bottom plate form an accommodating cavity; the drive unit, the transmission mechanism, and the control module are all located in the shell; and the shell is fixed on the fixing mechanism, and the fixing mechanism is configured to be able to be fixedly connected to a pipe connected to the valve.

In some implementations, optionally, the fixing mechanism comprises an integrally molded support, the support comprises a first fixing portion and a second fixing portion, the first fixing portion is connected to the bottom plate, and the second fixing portion is configured to be able to be fixed on the pipe.

In some implementations, optionally, the second fixing portion comprises a first V-shaped fastening surface disposed at an end portion of the support and configured to be attached to the pipe.

In some implementations, optionally, the second fixing portion further comprises two opposite slots provided in an upper side of the first V-shaped fastening surface; and the second fixing portion is configured to be attached to the pipe and to pass through the two slots by using a fastening belt.

In some implementations, optionally, the fixing mechanism further comprises a fastening sheet, and the fastening sheet is configured to be disposed on the pipe relative to the first V-shaped fastening surface and to be connected to the first V-shaped fastening surface by a fastening member.

In some implementations, optionally, the second fixing portion comprises an insertion sheet disposed at an end portion of the support, the fixing mechanism further comprises a fastening base, and the fastening base comprises an insertion slot matching the insertion sheet, a second V-shaped fastening surface configured to be attached to the pipe, and two slots for a fastening belt to pass through.

The present invention further provides a method for controlling a valve using a valve control device, the valve control device being mounted on the valve, wherein the method comprises:

receiving a control signal;

detecting a switching status of the valve;

driving an execution mechanism, to turn on or off the valve;

detecting a current; and

determining whether the current reaches a stall current,

where when the current reaches the stall current, the turning on or off of the valve is ended.

In some implementations, optionally, the control signal is from a leakage detection device or a user terminal.

In some implementations, optionally, the valve control device receives the control signal in an electrical connection manner, a wired network communication manner or a wireless communication manner.

In some implementations, optionally, the control signal comprises an instruction of turning on the valve or an instruction of turning off the valve.

In some implementations, optionally, the method further comprises: when the switching status satisfies the turn-on instruction or turn-off instruction, continuously monitoring the switching status.

In some implementations, optionally, the method further comprises: when the current does not reach the stall current, repeatedly performing the following steps: detecting a current, and determining whether the current reaches the stall current.

In some implementations, optionally, the valve control device detects the current by using a current detection unit.

In some implementations, optionally, the valve control device comprises a trigger member and a trigger unit, and the trigger member is configured to be able to trigger the trigger unit when the valve rotates to a preset position; and the valve control device is triggered by the trigger unit to detect the current.

The valve control device according to the present invention has the following beneficial technical effects:

1. The valve control device can be mounted on an existing manually operated valve to implement real-time monitoring and remote operation. When a gas leakage situation, a water leakage situation or the like occurs, the valve can be turned off in time, to avoid that a person is not on site and cannot handle a situation.
2. The valve control device is applicable to a universal existing valve structure without detaching and mounting an existing valve, can be directly mounted on the valve for adjustment and use, and can be conveniently detached.
3. An integral support structure is used for better fastening and higher stability.
4. A feedback component is used, so that a movement status of a valve can be fed back in time during operation, thereby performing operations accurately and effectively according to instructions. When the device is out of power or a person is present near the valve, a manual operation can be implemented.

The concept, the specific structure and the technical effects of the present invention will be further described in conjunction with the accompanying drawings in order to fully understand the objects, features and effects of the present invention.

### BRIEF DESCRIPTION OF THE DRAWINGS

FIG. 1 is a schematic diagram of an overall structure according to Embodiment 1;

FIG. 2 is a schematic diagram from another perspective of FIG. 1;

FIG. 3 is a schematic diagram of an internal structure of a control portion;

FIG. 4 is a schematic diagram from another perspective of FIG. 3;

FIG. 5 is a front view of FIG. 3;

FIG. 6 is a schematic structural diagram of a circuit board;

FIG. 7 is a schematic diagram of external communication;

FIG. 8 is a sectional view of FIG. 5 in a direction I-I;

FIG. 9 is a side view of FIG. 3;

FIG. 10 is an interface diagram of FIG. 9 in a direction II-II;

FIG. 11 is a schematic structural diagram of a first support;

FIG. 12 is a schematic structural diagram of a shell;

FIG. 13 is a flowchart of a method for controlling a valve using a valve control device;

FIG. 14 is a flowchart of a method for using a valve control device and a leakage detection device in combination;

FIG. 15 is a schematic structural diagram according to Embodiment 2;

FIG. 16 is a top view of FIG. 15;

FIG. 17 is a sectional view of FIG. 16 in a direction III-III;

FIG. 18 is a schematic structural diagram of an adjustment mechanism;

FIG. 19 is a schematic diagram of the structure and assembly of a slide block sheet;

FIG. 20 is a side view of FIG. 15;

FIG. 21 is a schematic structural diagram according to Embodiment 3; and

FIG. 22 is a front view of FIG. 21.

In the figures: 100—Control portion, 101—First circuit board, 102—Second circuit board, 103—Power cable, 104—Control module, 105—Communication module, 106—Detection module, 107—Wireless communication link, 108—Operation terminal, 109—Leakage detection device, 110—Touch switch, 111—Button, 120—Drive unit, 121—Drive unit output shaft, 131—Driving gear, 132—First driven gear, 133—Second driven gear, 134—Nut, 135—First protrusion, 136—Second protrusion, 137—Second driven gear output shaft, 138—Avoidance slot, 141—Pull shaft, 142—Elastic element, 143—Pull ring, 144—Flange, 151—Housing, 152—Bottom plate, 153—Second cavity, 154—Fixing column, and 155—First cavity;

200—First execution mechanism, 201—First block sheet, 202—Second block sheet, 210—Second execution mechanism, 213—Locking portion, 214—Pin shaft, 215—First slide block sheet, 216—First slide portion, 217—First block portion, 218—First slide groove, 219—Third slide groove, 220—Locking knob, 225—Second slide block sheet, 226—Second slide portion, 227—Second block portion, and 228—Second slide groove;

300—Fixing mechanism, 301—First support, 302—First fixing portion, 303—Second fixing portion, 304—First V-shaped fastening surface, 305—Ear portion, 306—First fastening belt, 307—First screw, 308—Slot, 310—Second support, 311—Second V-shaped fastening surface, 312—First flank portion, 320—Fastening sheet, 321—Third V-shaped fastening surface, 322—Second flank portion, 313—Second screw, 331—Third support, 332—Insertion sheet, 340—Fastening base, 341—Fourth V-shaped fastening surface, 342—Insertion slot, 343—Second fastening belt, and 344—Pin; and

400—Valve assembly, 410—Valve, 420—Handle, 430—Pipe, and 440—Rotating shaft.

### DETAILED DESCRIPTION OF THE PREFERRED EMBODIMENTS

Preferred embodiments of the present invention are described below with reference to the drawings of the description to make the technical contents clearer and easier to understand. The present invention can be embodied in various forms of embodiments, and the scope of protection of the present invention is not limited to the embodiments mentioned herein.

In the drawings, the same reference numeral indicates components having the same structure, and similar reference numerals indicate assemblies having similar structures or functions throughout. The size and thickness of each assembly shown in the figures are shown arbitrarily, and the present invention does not define the size and thickness of each assembly. In order to make the illustration clearer, the thickness of the component in some places of the figures is appropriately exaggerated.

### Embodiment 1

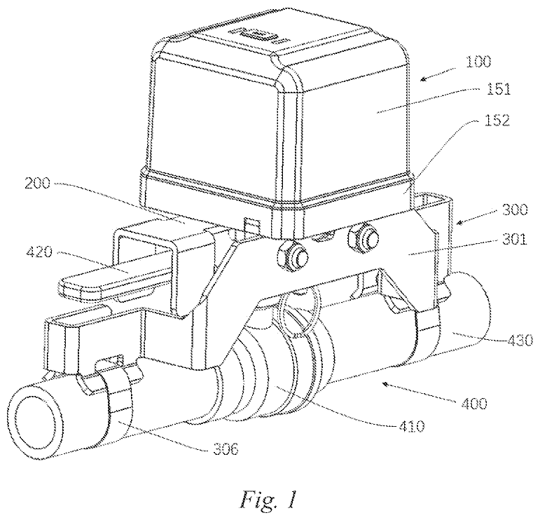

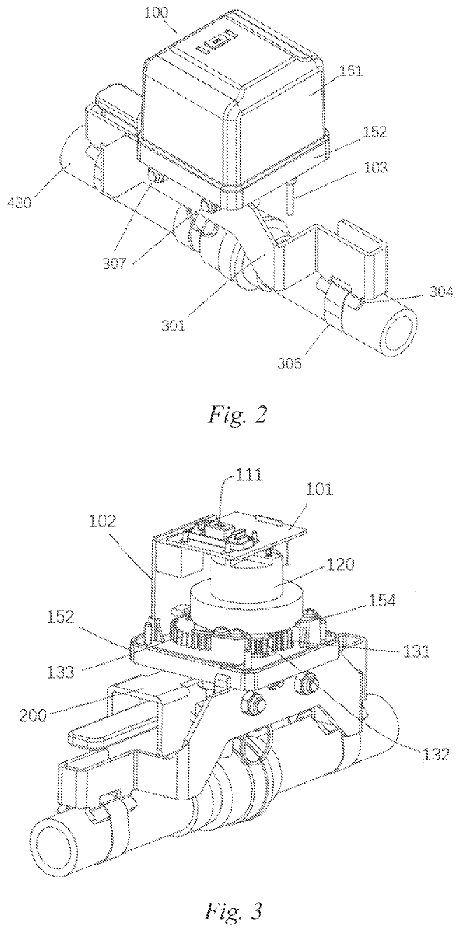

As shown in FIG. 1 and FIG. 2, this embodiment provides a valve control device, comprising a control portion 100, a first execution mechanism 200, and a fixing mechanism 300. The first execution mechanism 200 is connected to the control portion 100. The control portion 100 is fixed on the fixing mechanism 300. The fixing mechanism 300 is fixed on a valve assembly 400. The valve assembly 400 is an existing structure and comprises a valve 410, a handle 420 for controlling the valve 410, and a pipe 430 connected to the valve 410. The pipe 430 may be a pipe configured to allow water or gas to flow through. The handle 420 is manually rotated to turn on and/or off the valve 410. The first execution mechanism 200 is attached to the handle 420. The control portion 100 can control the first execution mechanism 200 according to a received signal to move, and the first execution mechanism 200 then drives the handle 420 to automatically turn on or off the valve 410. The control portion 100 and the first execution mechanism 200 are connected together and are then mounted on the fixing mechanism 300. The fixing mechanism 300 is then fixed on the pipe 430 connected to the valve. Therefore, the valve control device provided in this embodiment may be directly mounted at an existing valve structure, and it is not necessary to detach and mount an existing valve, and mounting is convenient.

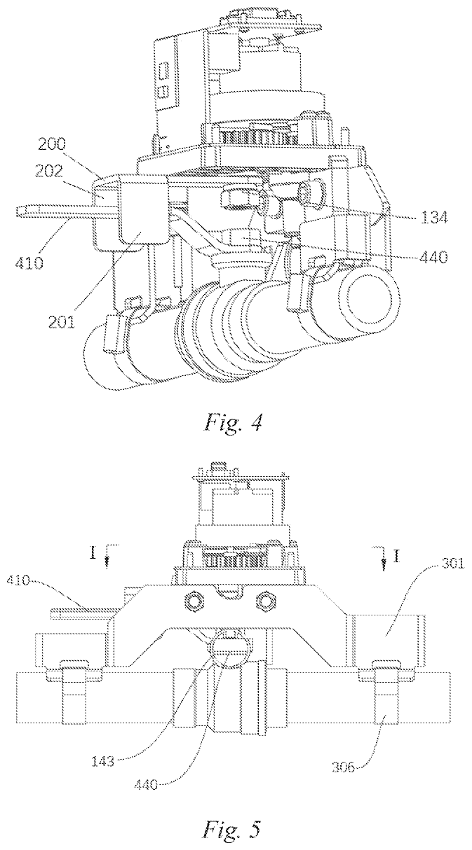

In the valve assembly 400 shown in FIG. 1, the handle 420 has a long rod shape, and the first execution mechanism 200 is attached to the handle 420. The valve control device in this embodiment is not limited to being applied to the valve assembly 400 shown in FIG. 1. The valve control device in this embodiment may also be used in another type of valve assembly, for example, a valve with a disk-shaped handle. The shape of the first execution mechanism 200 is changed to enable the first execution mechanism to match the disk-shaped handle 420, so as to control the valve. In addition, the first execution mechanism 200 may further be directly attached to a rotating shaft 440 (shown in FIG. 4) of the valve, to directly control the rotation of the rotating shaft 440 to turn off and/or on the valve 410.

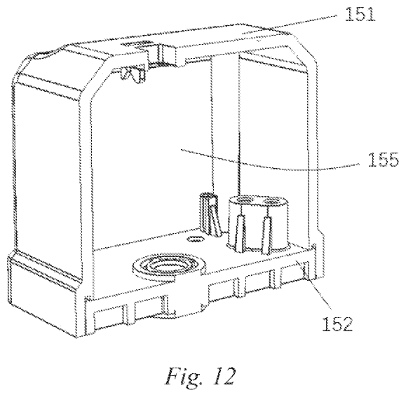

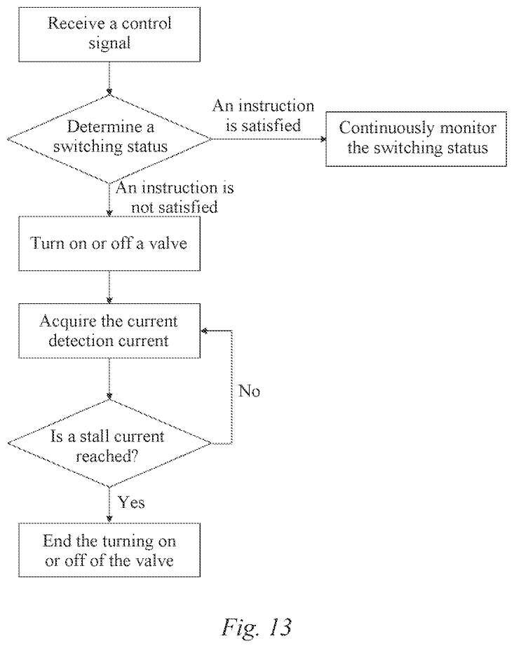

As shown in FIG. 2 and FIG. 3, the control portion 100 comprises a shell formed by a housing 151 and a bottom plate 152. The housing 151 and the bottom plate 152 enclose a first cavity 155 (shown in FIG. 12). A circuit board, a drive unit 120, and a transmission mechanism are placed in the first cavity 155. An output shaft of the transmission mechanism passes through the bottom plate 152 to be connected to the first execution mechanism 200. The control portion 100 further comprises a power cable 103 configured to be connected to a power source to power the control portion 100. The control portion 100 may be alternatively powered by a battery.

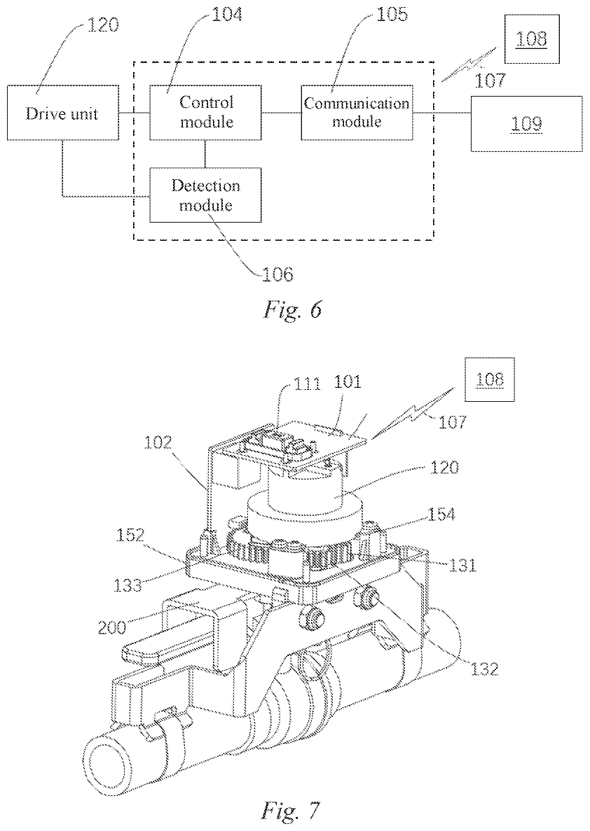

A block diagram of a functional structure of the circuit board is shown in FIG. 6 and comprises a control module 104, a communication module 105, and a detection module 106. As shown in FIG. 7, the communication module 105 is configured to communicate with the outside, acquire a control instruction, and send status information of the valve. The communication module 105 uses a wireless communication link 107 to communicate with an operation terminal 108 to obtain a control instruction of turning off the valve or turning on the valve. In addition, the communication module 105 may further be connected to a leakage detection device 109. When the leakage detection device 109 detects water leakage, gas leakage or the like, the leakage detection device 109 sends a signal to the communication module 105. The wireless communication link 107 may be based on any existing wireless communication protocol, for example, Bluetooth, ZigBee or a WLAN. The control module 104 responds to the signal received by the communication module 105 to control the drive unit 120 to move, to drive the first execution mechanism 200 to turn off or on the valve 410. The detection module 106 is configured to detect a movement status of the valve 410 and feeds back the movement status to the control module 104, so that it can be precisely controlled whether the valve 410 rotates to a preset position. For example, it may be detected that whether the valve 410 is in an on position or an off position. In some implementations, the control module 104, the communication module 105, and the detection module 106 are integrated in one circuit board. In a preferred implementation, as shown in FIG. 3, two circuit boards, that is, a first circuit board 101 and a second circuit board 102, may be disposed. The first circuit board 101 is disposed at a top end on an inner side of the housing 151. The second circuit board 102 is perpendicular to the first circuit board 101 and is disposed on a side surface of an inner side of the housing 151. The first circuit board 101 has the control module 104 for controlling the drive unit 120 and the communication module 105 for receiving an external signal. The second circuit board 102 has the detection module 106 for detecting the movement status and movement position of the valve 410. The first circuit board 101 and the second circuit board 102 perform data transmission in an electrical connection manner, so as to transmit a signal detected by the detection module 106 to the control module 104. Preferably, the first circuit board 101 is further provided with a button 111, configured to turn on, restart, turn off or perform an operation on the valve control device.

The drive unit 120 is connected to the first circuit board 101, and the drive unit 120 is preferably a motor. The drive unit 120 is fixed on the bottom plate 152 by a fixing column 154. The transmission mechanism is disposed on the bottom plate 152. A drive unit output shaft 121 is connected to the first execution mechanism 200 by the transmission mechanism, so that the rotation of the motor is transferred to the first execution mechanism 200.

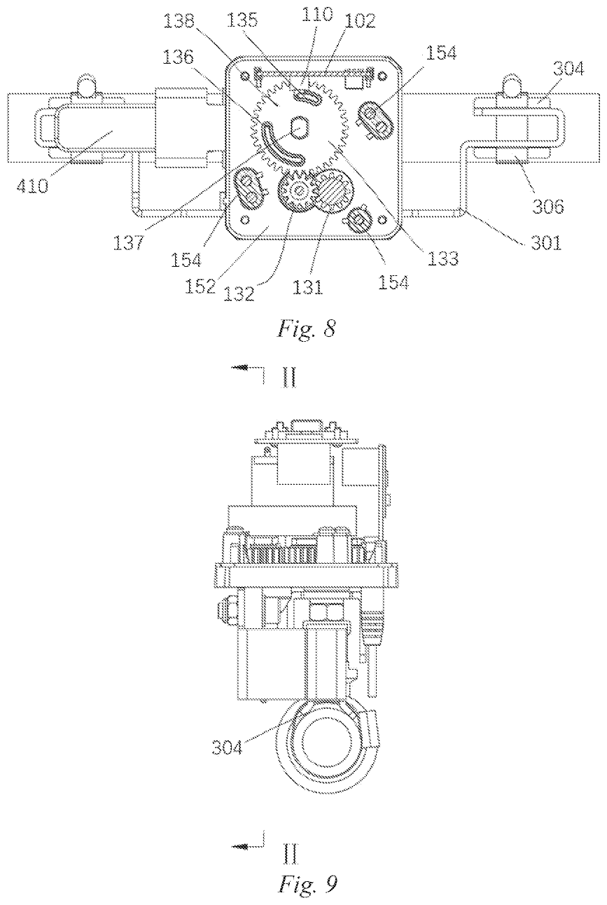

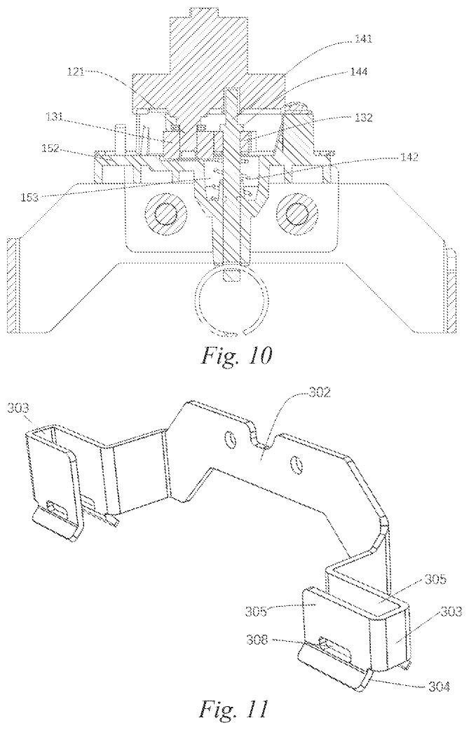

As shown in FIG. 8 and FIG. 10, the transmission mechanism is a gear structure and comprises a driving gear 131 fixedly connected to the drive unit output shaft 121 and a driven gear engaged with the driving gear 131. In some implementations, only one driven gear may be disposed, and the driven gear is then engaged with the driving gear 131 and is at the same time fixedly connected to the first execution mechanism 200, to implement the rotation of the first execution mechanism 200. Preferably, a first driven gear 132 and a second driven gear 133 are disposed in this embodiment. The first driven gear 132 is engaged with the driving gear 131. The second driven gear 133 is engaged with the first driven gear 132. A second driven gear output shaft 137 passes through the bottom plate 152 to be fixedly connected to a first end of the first execution mechanism 200 by a nut 134 (shown in FIG. 4). The transmission mechanism is not limited to the gear structure in this embodiment, and another manner of transmission mechanism such as a belt transmission structure, a bevel gear structure or a chain transmission structure can implement the function in this embodiment.

The valve control device in this embodiment further comprises a switching mechanism can switch the valve control device from an electric control mode to a control mode of manually rotating a valve. Specifically, as shown in FIG. 9 and FIG. 10, the switching mechanism comprises a pull shaft 141, an elastic element 142, and a pull ring 143. A second cavity 153 protruding in a direction away from the housing 151 is provided at a position of the first driven gear 132 on the bottom plate 152. The pull shaft 141 passes through the second cavity 153 to be connected to the first driven gear 132. The first driven gear 132 is sheathed over the pull shaft 141. The pull shaft 141 is provided with a flange 144. The diameter of the flange 144 is greater than the diameter of a hole at which the first driven gear 132 matches the pull shaft 141, so that the flange 144 abuts against the first driven gear 132. The elastic element 142 is located in the second cavity 153 and is disposed on the pull shaft 141. The elastic element 142 applies an elastic force to the first driven gear 132, so that the first driven gear 132 is kept at a position in engagement with the driving gear 131. The elastic element 142 is preferably a spring. An end, protruding from the bottom plate 152, of the pull shaft 141 is provided with the pull ring 143 to facilitate operation. The pull ring 143 is manually pulled to overcome the elastic force of the elastic element 142, so that the pull shaft 141 moves in a direction away from the transmission mechanism. Driven by the flange 144, the first driven gear 132 moves together with the pull shaft 141 to be disengaged from the driving gear 131 and the second driven gear 133. In this case, the second driven gear 133 is in a disengaged state, and the handle 420 is manually rotated to implement the manual operation of the valve. In some implementations, the pull shaft 141 and the first driven gear 132 may use an interference fit manner, so that the flange 144 may be omitted. Alternatively, the pull shaft 141 is connected to the first driven gear 132 by a thread or the flange 144 may be omitted. Another connection manner that enables the first driven gear 132 to move together with the pull shaft 141 is applicable to this embodiment.

The detection module 106 is configured to feed back a rotational status of the valve 410 and at least comprises one of a current detection unit and a non-current detection unit.

The current detection unit is connected to the control module 104 and is configured to detect a current of the drive unit 120. When the current is greater than a preset current value, it may be determined that the valve 410 rotates to the preset position, for example, a position at which the valve is turned off.

The non-current detection unit is preferably a trigger unit. In some implementations, an angle sensor may be used. When the angle sensor rotates to a preset angle, a signal transmission device sends a signal indicating that the valve rotates in position, to feed back a rotational status of the valve. In some implementations, a combination of a trigger member and the trigger unit is used. For example, the trigger member is disposed in the valve control device. The trigger member moves together with the first execution mechanism 200. When the valve 410 is in an on position, the trigger member is in contact with the trigger unit and sends a status signal of the valve 410. When the valve 410 is in an off position, the trigger member is in contact with the trigger unit and sends a status signal of the valve 410. Preferably, as shown in FIG. 8, the second driven gear 133 is provided with a first protrusion 135 and a second protrusion 136 as the trigger member. The second circuit board 102 is provided with a touch switch 110. An avoidance slot 138 is formed between the first protrusion 135 and the second protrusion 136. When pre-installed, the touch switch 110 is located in the avoidance slot 138 to avoid current detection by the equipment. In an initial state, the valve 410 is in an on position, the first protrusion 135 is in contact with the touch switch 110 to implement current detection, and sends a detected signal. As the second driven gear 133 rotates, the second protrusion 136 is close to the touch switch 110, to implement current detection when the valve 410 is in an off position. The first protrusion 135 and the second protrusion 136 ensure current detection of the valve control device when the valve is at two extreme positions of an on position and an off position, so as to feed back whether the rotating shaft 440 of the valve assembly rotates to the preset position. A touch unit is not limited to the touch switch 110, and may be a photoelectric sensing device, an electromagnetic sensing device or the like.

As shown in FIG. 4, one end of the first execution mechanism 200 is fixed on the second driven gear output shaft 137 (shown in FIG. 8) by the nut 134. The first execution mechanism 200 rotates as the second driven gear 133 rotates. The other end of the first execution mechanism 200 is attached to the handle 420 of the valve. To enable the first execution mechanism 200 to rotate to drive the handle 420 to rotate along, the first execution mechanism 200 is provided with a first block sheet 201 and a second block sheet 202. An accommodating space is formed between the first block sheet 201 and the second block sheet 202. The handle 420 is placed in the accommodating space. When the first execution mechanism 200 rotates, the first block sheet 201 or the second block sheet 202 drives the handle 420 to rotate along, to turn on or off the valve.

The fixing mechanism 300 is configured to mount the control portion 100 and at the same time implement a connection to the pipe 430, so as to fix the valve control device. As shown in FIG. 1 and FIG. 11, the fixing mechanism 300 comprises a first support 301. The first support 301 comprises a first fixing portion 302 configured to mount the control portion 100 and a second fixing portion 303 configured to be fixed on the pipe 430. When the first support 301 is fixed on the pipe 430, a gap is formed between the first fixing portion 302 and the pipe 430, so that the control portion 100 fixed on the first fixing portion 302 does not interfere with the valve, making it convenient to attach the first execution mechanism 200 to the handle 420. In this embodiment, the second fixing portion 303 is fixed on the pipe 430 in a fastening belt manner. As shown in FIG. 11, two second fixing portions 303 are provided in this embodiment and are respectively located on two ends of the first support 301. The two second fixing portions 303 have the same structure. One of the second fixing portions 303 is used as an example for description below. An end portion of the first support 301 bends twice to form two opposite ear portions 305. Sides, facing the pipe 430, of the two ear portions 305 separately bend outward, to form a first V-shaped fastening surface 304. A V-shaped surface of the first V-shaped fastening surface 304 can be desirably attached to the pipe 430. Upper sides, located on the first V-shaped fastening surface 304, of the two ear portions 305 are separately provided with two slots 308 for a first fastening belt 306 to pass through. During mounting, as shown in FIG. 1, the first V-shaped fastening surface 304 is attached to the pipe 430, and the first fastening belt 306 is then used to pass through the two slots 308, so that the first support 301 is fixed on the pipe 430.

The first support 301 may be preferably integrally molded, thereby achieving more stable fastening.

As shown in FIG. 13, a method for using the valve control device provided in this embodiment to control the valve 410 comprises the following steps:

receiving a control signal;

detecting a switching status of the valve;

driving an execution mechanism, to turn on or off the valve;

detecting a current; and

determining whether the current reaches a stall current,

where when the current reaches the stall current, the turning on or off of the valve is ended.

Specifically, the control portion 100 receives from an external control signal. The control signal may comprise an instruction of turning on the valve 410 or an instruction of turning off the valve 410. The control portion 100 responds to the control signal to determine the current switching status of the valve 410. If the control signal comprises an instruction of turning on the valve 410 and the valve 410 is in an on state, that is, the switching status of the valve 410 satisfies an instruction of turning on the valve 410, the control portion 100 continuously monitors the switching status of the valve 410. Alternatively, the control signal comprises an instruction of turning off the valve 410 and the valve 410 is in an off state, that is, the switching status of the valve 410 satisfies an instruction of turning off the valve 410, the control portion 100 continuously monitors the switching status of the valve 410. In some implementations, the control signal is from a leakage detection device. The leakage detection device may be connected to the valve control device in an electrical connection manner. When it is detected that leakage occurs, an electrical signal is sent to the valve control device. The leakage detection device may alternatively communicate with the valve control device by using a wired communication network or a wireless communication network. In some implementations, a user may use a terminal to send the control signal to the valve control device. For example, the user uses an APP installed on a smart phone to communicate with the valve control device and send the control signal, to remotely control the valve 410.

If the control signal comprises an instruction of turning on the valve 410 and it is detected that the valve 410 is in an off state, the control portion 100 starts to control the drive unit to drive the first execution mechanism 200 to move, so that the handle 420 is rotated to turn on the valve 410. In the process of turning on the valve, the control portion 100 detects whether a current reaches the stall current to determine whether the valve is rotated in position. In some implementations, the current detection unit is used to detect the current and determine whether the current reaches the stall current. In some implementations, a trigger element is used for detection. When the trigger element is triggered, it represents that the handle 420 has moved to an on position. In addition, the current detection unit may be used again in this case to detect whether the current reaches the stall current. If the control signal comprises an instruction of turning off the valve 410, execution steps of the instruction are the same as the operation of turning on the valve.

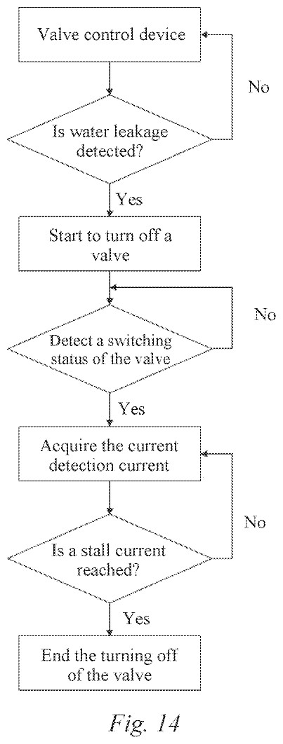

FIG. 14 shows a working procedure when the valve control device is connected to the leakage detection device. When it is detected that water leakage occurs, the action of turning off the valve starts to be performed. The switching status of the valve is then determined. If the valve is in an off state, the switching status of the valve is continuously monitored. If the valve is still in an on state, a detected current at this time is acquired, and it is determined whether the current reaches the stall current. If the current does not reach the stall current, a current status is repeatedly detected. When it is detected that the stall current is reached, it represents that the valve is turned off, and the action of turning off the valve is ended.

For the valve control device shown in this embodiment, the integrally molded first support 301 is mounted on the pipe 430 in a fastening belt manner. The control portion 100 is mounted on the first support 301. In addition, the control portion 100 receives a signal and controls the first execution mechanism 200 according to the signal to rotate the handle 420, to intelligently and remotely control an existing manual valve assembly, thereby avoiding a water leakage situation or a gas leakage situation caused by untimely response. The working principle of turning off the valve by the valve control device in this embodiment is as follows: It is determined whether an external signal, for example, a signal from the leakage detection device 109 or a control signal of the operation terminal 108, is received. If the external signal is received, a process of turning off the valve starts to be entered. When the valve starts to be turned off, the control portion 100 controls the drive unit 120 to drive the first execution mechanism 200 to rotate. At the same time, a current is detected, and it is determined whether the stall current when the valve is turned off is reached. If the stall current is reached, it represents that the valve has been turned off, and work ends. If the detected current represents that the stall current is still not reached, it represents that the valve has not been turned off, and the first execution mechanism 200 continues to be controlled to turn off the valve.

### Embodiment 2

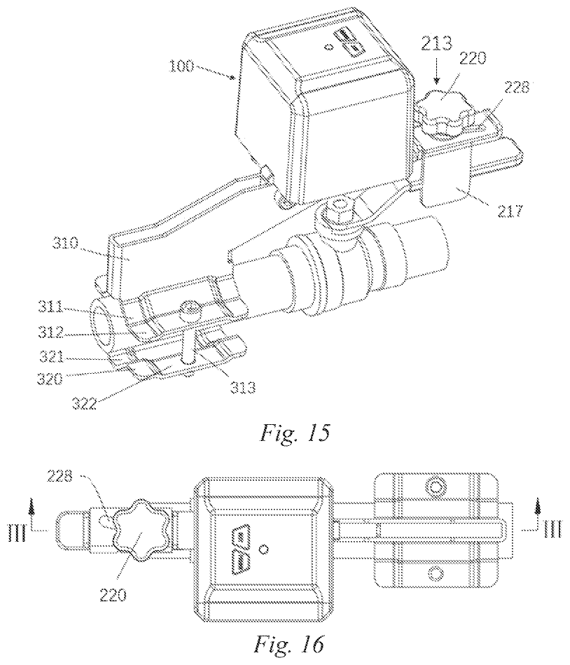

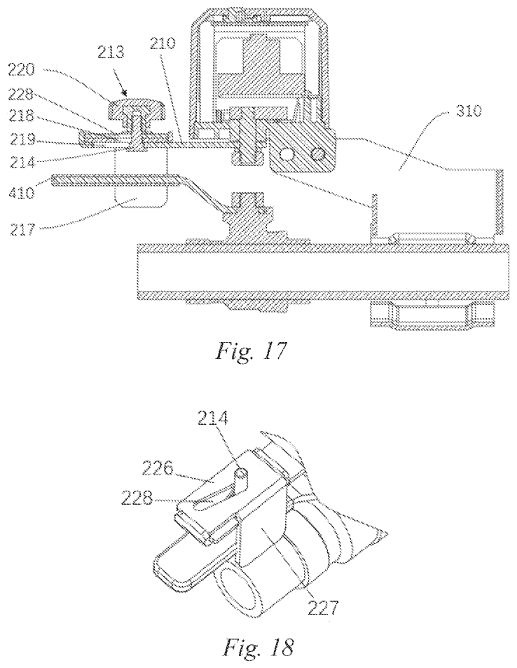

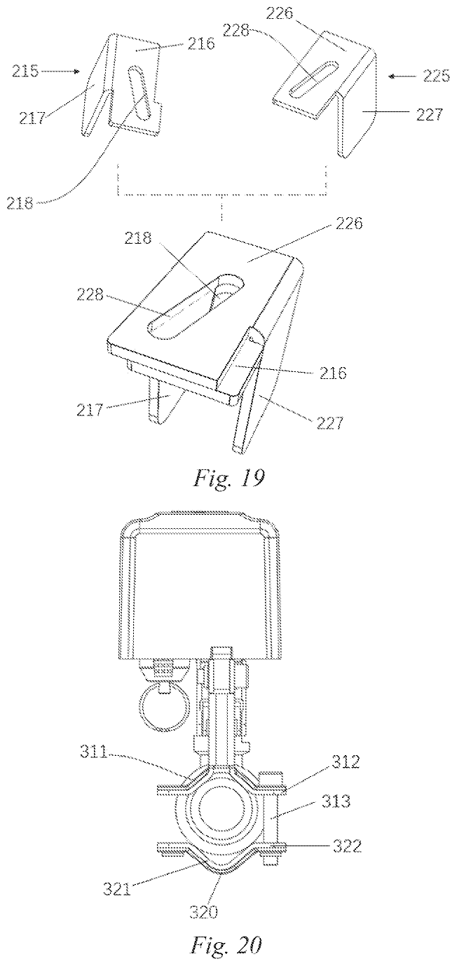

FIG. 15 to FIG. 20 show Embodiment 2. This embodiment is different from Embodiment 1 in the structure in which an execution mechanism is attached to the handle 420 and the structure in which the support is fixed on the pipe 430. Therefore, only differences from Embodiment 1 are only described herein.

In Embodiment 1, the first execution mechanism 200 can only be attached to a handle of a specific size and is not applicable to handles of different sizes. To resolve this problem, in this embodiment, a second execution mechanism 210 is provided with an adjustment mechanism. The adjustment mechanism comprises a locking portion 213, a first slide block sheet 215, and a second slide block sheet 225. The first slide block sheet 215 is L-shaped and comprises a first slide portion 216 and a first block portion 217. The first slide portion 216 is obliquely provided with a first slide groove 218. The second slide block sheet 225 has a structure similar to that of the first slide block sheet 215 and comprises a second slide portion 226, a second block portion 227, and a second slide groove 228 obliquely disposed on the second slide portion 226. The first slide block sheet 215 and the second slide block sheet 225 are disposed opposite at an end portion of the second execution mechanism 210. The first block portion 217 and the second block portion 227 are opposite to form a space for accommodating the handle 420. The first slide portion 216 and the second slide portion 226 are both superimposed on the second execution mechanism 210 and are slidable in a direction perpendicular to a lengthwise direction of the second execution mechanism 210. In this case, the first slide groove 218 and the second slide groove 228 are in a cross state. The locking portion 213 comprises a locking knob 220 and a pin shaft 214. The pin shaft 214 passes through the first slide groove 218, the second slide groove 228, and a third slide groove 219 on the second execution mechanism 210 to be connected to the locking knob 220. A threaded connection is used between the locking knob 220 and the pin shaft 214 to implement tightening or loosening. The locking knob 220 is loosened, and the pin shaft 214 moves in the lengthwise direction of the second execution mechanism 210. Because of the limiting effect of the first slide groove 218 and the second slide groove 228, the first slide block sheet 215 and the second slide block sheet 225 can slide relative to each other, so that the distance between the first block portion 217 and the second block portion 227 can be increased or reduced, to adapt to handles 420 of different sizes.

In this embodiment, the fixing mechanism 300 comprises a second support 310 and a fastening sheet 320 separate from the second support 310. The first fixing portion of the second support 310 is configured to fix the control portion 100. The second fixing portion of the second support 310 is located at an end portion of the second support and is configured to be fixed on the pipe 430. The second fixing portion of the second support 310 is provided with a second V-shaped fastening surface 311 and may be attached to the pipe 430. The fastening sheet 320 cooperates with the second V-shaped fastening surface 311 on the second support 310. As shown in FIG. 15 and FIG. 20, the second V-shaped fastening surface 311 is disposed at an end portion of the second support 310. Two sides of the second V-shaped fastening surface 311 separately protrude in a direction away from the pipe 430 to form two first flank portions 312. The fastening sheet 320 has a shape similar to that of the second V-shaped fastening surface 311 and comprises a third V-shaped fastening surface 321 attached to the pipe 430 and a second flank portion 322 opposite the first flank portions 312. Each of the first flank portions 312 and the second flank portion 322 is provided with a mounting hole. During mounting, the fastening sheet 320 is located on a side, opposite the second support 310, of the pipe 430. A fastening member, for example, a second screw 313, is used to pass through the mounting holes on the first flank portions 312 and the second flank portion 322, so that the pipe 430 is tightly sandwiched between the second V-shaped fastening surface 311 and the third V-shaped fastening surface 321. By means of a fastening manner in this embodiment, stable fixation can be achieved only by disposing the second V-shaped fastening surface 311 at an end of the second support 310. The second support 310 may be manufactured in an integral molding manner.

### Embodiment 3

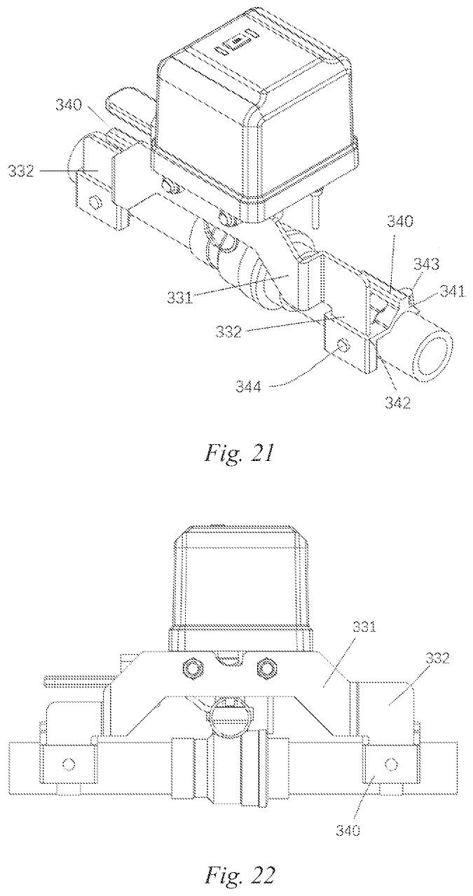

FIG. 21 and FIG. 22 show Embodiment 3. Compared with Embodiment 1, a difference only lies in the structure in which an execution mechanism is attached to the handle 420.

As shown in FIG. 21, the fixing mechanism 300 comprises a third support 331 and a fastening base 340 separate from the third support 331. Two ends of the third support 331 are separately provided with the second fixing portion. Specifically, the second fixing portion of the third support 331 is provided with an insertion sheet 332. The fastening base 340 comprises a fourth V-shaped fastening surface 341 attached to the pipe 430, a through hole configured to pass through a second fastening belt 343, and an insertion slot 342 configured to insert the insertion sheet 332. During mounting, two same fastening bases 340 are first separately tightly tied on the pipe 430 by the second fastening belt 343, and the positions of the two fastening bases 340 correspond to those of two insertion sheets 332 of the third support 331. The insertion sheet 332 of the third support 331 is then inserted in the insertion slot 342, and the fastening member is used to fix the insertion sheet 332 in the insertion slot 342.

The specific preferred embodiment of the present invention is described in detail as above. It should be appreciated that a person of ordinary skill in the art would be able to make modifications and variations in accordance with the concept of the present invention without involving any inventive effort. Therefore, any technical solution that can be obtained by a person skilled in the art by means of logical analysis, reasoning or limited trials on the basis of the prior art and according to the concept of the present invention should be included within the scope of protection of the claims.

1. A valve control device, comprising:
a drive unit;
an execution mechanism, connected to the drive unit by a transmission mechanism, and configured to be able to be attached to a valve and be able to move under the drive of the drive unit, so as to drive the valve to rotate; and
a control module, connected to the drive unit, and configured to be able to control the drive unit.

2. The valve control device according to claim 1, further comprising:
a communication module, connected to the control module, and configured to be able to: receive a control signal about the valve, and provide the control signal to the control module, wherein
the control module is further configured to be able to respond to the control signal provided by the communication module to correspondingly control the drive unit according to the control signal.

3. The valve control device according to claim 1, further comprising:
a detection module, configured to be able to: detect position information of the valve, and provide the position information to the control module, wherein the control module is further configured to be able to correspondingly control the drive unit according to the position information.

4. The valve control device according to claim 3, wherein the detection module comprises a current detection unit, the current detection unit is connected to the drive unit, and the current detection unit is configured to be able to detect whether a current of the drive unit is greater than a preset value so as to generate information about whether the valve rotates to a preset position;
wherein the detection module comprises a trigger unit, and the trigger unit is configured to be able to be triggered to generate a signal indicating that the valve rotates in position when the valve rotates to the preset position.

5. The valve control device according to claim 4, wherein the valve control device further comprises a trigger member; and the trigger member is configured to be able to: rotate along with the execution mechanism, and trigger the trigger unit when the valve rotates to the preset position.

6. The valve control device according to claim 5, wherein the transmission mechanism comprises:
a driving gear, connected to the drive unit, and capable of rotating under the drive of the drive unit; and
at least one driven gear, capable of correspondingly rotating along with the drive of the driving gear, wherein one of the at least one driven gear is connected to the execution mechanism and is provided with the trigger member.

7. The valve control device according to claim 6, wherein the trigger member comprises a first protrusion and a second protrusion; the first protrusion is configured to be able to trigger the trigger unit when the valve is located at a first position; and the second protrusion is configured to be able to trigger the trigger unit when the valve is located at a second position.

8. The valve control device according to claim 6, wherein the at least one driven gear comprises:
a first driven gear, engaged with the driving gear; and
a second driven gear, engaged with the first driven gear, wherein the second driven gear is connected to the execution mechanism, and the second driven gear is provided with the trigger member.

9. The valve control device according to claim 8, wherein the valve control device further comprises a switching mechanism, and the switching mechanism is connected to the first driven gear.

10. The valve control device according to claim 9, wherein the switching mechanism comprises a pull shaft, an elastic element, and a pull ring, wherein the first driven gear is sheathed over the pull shaft and configured to be able to move along with the pull shaft, the elastic element is configured to apply an elastic force to the first driven gear, and the pull ring is disposed at an end portion, away from the first driven gear, of the pull shaft; and the switching mechanism is configured to: when the pull shaft is applied with a force in a direction away from the first driven gear, enable the first driven gear to be driven by the pull shaft and overcome the elastic force so as to be disengaged from the second driven gear.

11. The valve control device according to claim 1, wherein the execution mechanism comprises a first block sheet and a second block sheet that are arranged opposite each other, and an accommodating space capable of placing a handle is formed between the first block sheet and the second block sheet.

12. The valve control device according to claim 11, wherein the execution mechanism is provided with an adjustment mechanism, and the adjustment mechanism is configured to be able to adjust a gap between the first block sheet and the second block sheet.

13. The valve control device according to claim 12, wherein the adjustment mechanism comprises: a first slide groove provided in the first block sheet, a second slide groove provided in the second block sheet, and a locking portion, wherein the first slide groove and the second slide groove are configured to be disposed in an overlapping cross manner, and the locking portion passes through the first slide groove and the second slide groove.

14. The valve control device according to claim 1, wherein the valve control device further comprises a fixing mechanism and a shell, wherein the shell comprises a housing and a bottom plate which form an accommodating cavity; the drive unit, the transmission mechanism, and the control module are all located in the shell; and the shell is fixed on the fixing mechanism, and the fixing mechanism is configured to be able to be fixedly connected to a pipe connected to the valve.

15. The valve control device according to claim 14, wherein the fixing mechanism comprises an integrally molded support, the support comprises a first fixing portion and a second fixing portion, the first fixing portion is connected to the bottom plate, and the second fixing portion is configured to be able to be fixed on the pipe.

16. A method for controlling a valve using a valve control device, the valve control device being mounted on the valve, wherein the method comprises:
receiving a control signal;
detecting a switching status of the valve;
driving an execution mechanism, to turn on or off the valve;
detecting a current; and
determining whether the current reaches a stall current,
where when the current reaches the stall current, the turning on or off of the valve is ended.

17. The method according to claim 16, wherein the control signal is from a leakage detection device or a user terminal.

18. The method according to claim 16, wherein the method further comprises: when the current does not reach the stall current, repeatedly performing the following steps: detecting a current, and determining whether the current reaches the stall current.

19. The method according to claim 16, wherein the valve control device detects the current by a current detection unit

20. The method according to claim 16, wherein the valve control device comprises a trigger member and a trigger unit, and the trigger member is configured to be able to trigger the trigger unit when the valve rotates to a preset position; and the valve control device is triggered by the trigger unit to detect the current.
